(19) United States
(12) Patent Application Publication
(10) Pub. No.: US 2005/0159925 A1
(43) Pub. Date: Jul. 21, 2005

(54) Cache testing for a processor design

(76) Inventor: Elias Gedamu, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/759,330

(22) Filed: Jan. 15, 2004

(51) Int. Cl. G06F 11/30

(52) U.S. Cl. 702/186

(57) ABSTRACT

Systems, methods, and computer programs for performing cache yield analysis of a processor design are provided. One embodiment is a method for testing cache performance of a processor design comprising: searching a file that contains cache test results for a lot of wafers; and determining at least one cache array location in at least one processor in the lot wafers processor for which a cache test has failed.

### BACKGROUND

Currently, a number of systems exist for testing various types of semiconductor-based devices. In general, such systems interface with the device-under-test (DUT) and perform various analyses to test the operation, functionality, etc. of the DUT. Typically, the results of these tests are logged to a results file for subsequent analysis to assess the processor design and/or the yield of the fabrication process.

Existing systems for analyzing the results file, however, are limited because of the large size of the file. The results file is typically very large because the test system performs a number of tests for each processor on each wafer in the lot.

### SUMMARY

Systems, methods, and computer are described. One embodiment is a cache yield analysis program embodied in a computer-readable medium comprising: logic configured to search a file that contains test results for a lot of wafers and determine cache array locations for processors in the lot for which a cache test has failed; and logic configured to determine a cache array repair signature that defines at least one cache array location associated with the processor design which has failed the cache test in a statistically relevant percentage of the processors in the lot. Another embodiment is a system for testing cache performance of a processor design comprising: a parser module for searching a file that contains cache test results for a lot of wafers; a composite repair failure identification module for determining cache array locations for which a cache test has failed; and a cache array repair signature module for determining at least one cache array location associated with the processor design which has failed the cache test in a statistically relevant percentage of the processors in the lot.

A further embodiment is a method for testing cache performance of a processor design comprising: searching a file that contains cache test results for a lot of wafers; and determining at least one cache array location in at least one processor in the lot wafers processor for which a cache test has failed.

Yet another embodiment is a system for testing cache performance of a processor design comprising: means for searching a file that contains test results for a lot of wafers; means for determining cache array locations for processors in the lot for which a cache test has failed; and means for generating a cache array repair signature that defines at least one cache array location associated with the processor design which has failed the cache test in a statistically relevant percentage of the processors in the lot.

### BRIEF DESCRIPTION OF THE DRAWINGS

Many aspects of the invention can be better understood with reference to the following drawings. The components in the drawings are not necessarily to scale, emphasis instead being placed upon clearly illustrating principles in accordance with exemplary embodiments of the present invention. Moreover, in the drawings, like reference numerals designate corresponding parts throughout the several views.

FIG. 1 is a block diagram of a testing environment for testing processors, which includes a cache yield analysis system.

FIG. 2 is a perspective view illustrating a lot of wafers that may be tested in the testing environment of FIG. 1.

FIG. 3 is a more detailed block diagram of a portion of the testing environment of FIG. 1 illustrating the general components of processors on the wafers of FIG. 2.

FIG. 4 is a simplified diagram illustrating an exemplary representation of the cache array in the processor of FIG. 3.

FIG. 5 is a flowchart illustrating the architecture, operation, and/or functionality of an embodiment of the cache yield analysis system of FIGS. 1 and 2.

FIG. 6 is a block diagram of another embodiment of the cache yield analysis system of FIGS. 1 and 2.

FIG. 7 is a flowchart illustrating one exemplary method for testing cache performance of a processor design.

### DETAILED DESCRIPTION

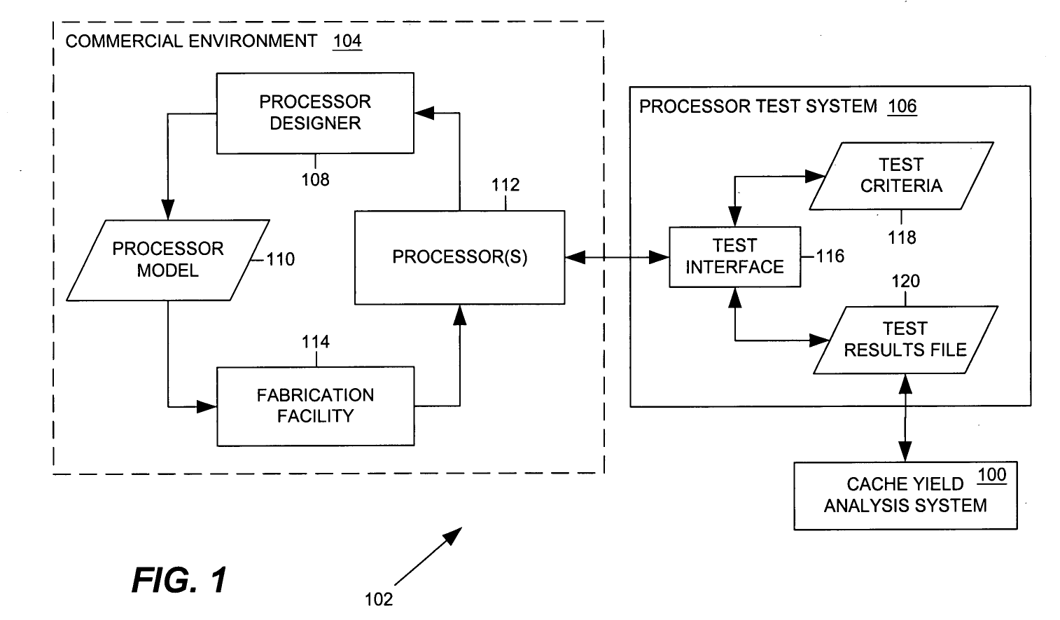

This disclosure relates to various embodiments of systems, methods, and computer programs for performing cache testing of a processor design. Several embodiments will be described below with reference to FIGS. 1-7. As an introductory matter, however, the basic architecture, operation, and/or functionality of an exemplary, non-limiting embodiment of a cache yield analysis system will be briefly described. In the exemplary embodiment, the cache yield analysis system is configured to interface with a file that contains results of various tests performed on processor(s) in a collection of wafers (i.e., lot). The cache yield analysis system is further configured to search the file and identify any cache array locations for which a cache test has failed. The cache yield analysis system may be further configured to analyze the identified cache array location(s) and generate a cache array repair signature. As described below in more detail, the cache array repair signature may define one or more cache array locations associated with the processor design that failed the cache test in a statistically relevant percentage of the processors in the lot. It should be appreciated that the cache array repair signature may be useful to processor designers and/or manufacturers to identify problem areas in either the processor design or in the processor fabrication process.

FIG. 1 illustrates an embodiment of a processor design/manufacture/test environment 102 in which various embodiments of a cache yield analysis system 100 may be implemented. As illustrated in the embodiment of FIG. 1, environment 102 comprises commercial environment 104, processor test system 106, and cache yield analysis system 100. In commercial environment 104, a processor designer 108 designs a processor to be manufactured. As further illustrated in FIG. 1, the architecture, functionality, layout (or floorplan), etc. may be embodied in a processor model 110 that may be provided to a fabrication facility 114 for manufacture. Fabrication facility 114 manufacturers processors 112 according to processor model 110. It should be appreciated that any type of processor may be designed and manufactured.

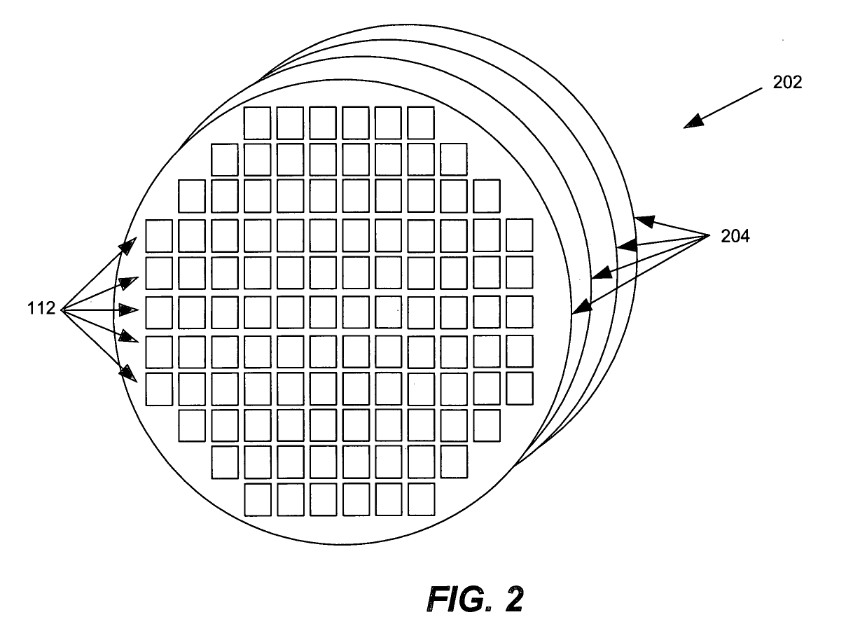

Referring to FIG. 2, it should be further appreciated that fabrication facility 114 typically manufactures a lot 202 of wafers 204. As known in the art, a wafer 204 comprises a number of processors 112. Referring again to FIG. 1, processor test system 106 may be used to test any aspect of processors 112 (e.g., operation, functionality, etc.) in lot 202, or various components of processors 112. In this regard, processor test system 106 comprises a test interface 116, test criteria 118, and a test results file 120.

Test criteria 118 may comprise a data file or logic that defines and/or controls the test(s) to be performed on processors 112. One of ordinary skill in the art will appreciate that any of a variety of types of tests may be performed on processors 112 and, therefore, test criteria 118 may be configured accordingly. As described in more detail below, various embodiments of test criteria 118 may be configured to test the cache components (e.g., instruction cache, data cache, etc.) of processors 112. For example, test criteria 118 may be configured to define and/or control a composite repair test for testing each bit in cache array(s) (e.g., row/column).

As illustrated in FIG. 1, test interface 116 provides the interface between test criteria 118 and processors 112 to be tested. Test interface 116 may be configured to provide the physical, functional, or other interface means between these components.

As known in the art, during operation of processor test system 106, the results of the tests performed on each processor 112, wafer 204, and/or the corresponding aspects of processors 112 or wafer 204 may be logged to test results file 120. Typically, due to the large number of tests being performed and the large number of processors 112, test results file 120 is relatively large. It should be appreciated that test results file 120 may be configured in a variety of ways. For example, test results file 120 may be represented in hexadecimal, binary, or other suitable data formats.

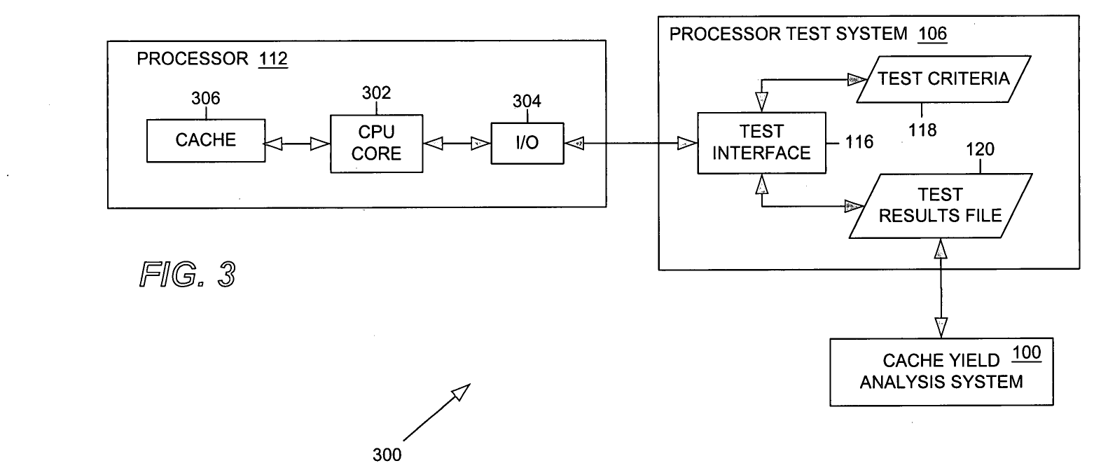

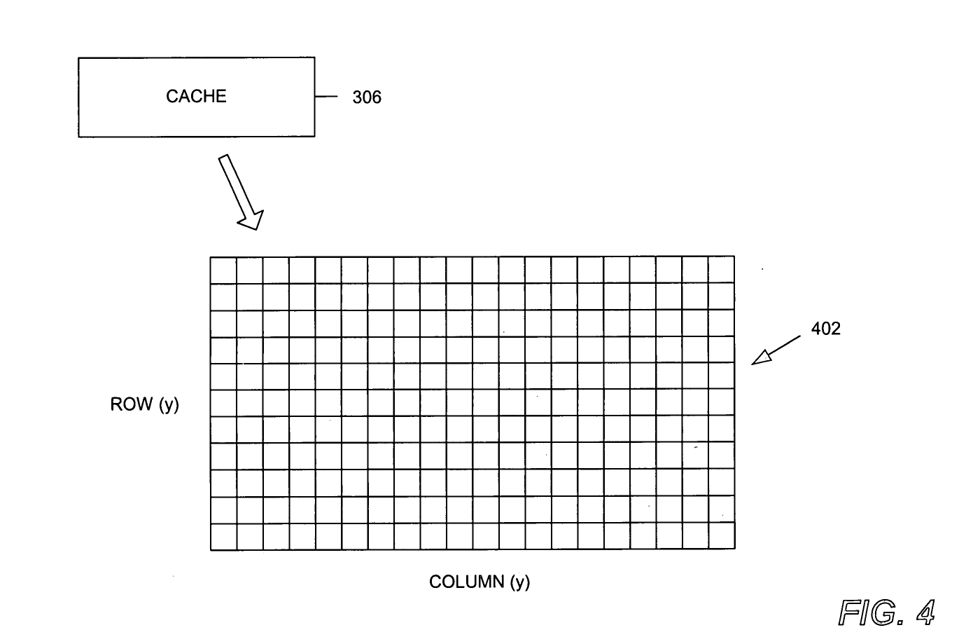

FIG. 3 illustrates an example of a processor architecture that may be employed in processors 112. In this embodiment, processor 112 comprises I/O 304, a CPU core 302, and cache 306. I/O 304 provides a mechanism by which processor test system 106 may test cache 306. As briefly mentioned above, test processor system 106 may test the cache components (e.g., instruction cache, data cache, etc.) of processors 112. In one embodiment, a composite repair test may be performed on cache 306 to test each bit in the corresponding cache array(s). Referring to FIG. 4, cache 306 may comprise a cache array 402 comprising various rows and columns. It should be appreciated that cache array 402 may be configured in a variety of ways and need not be configured in a symmetrical array. Rather, cache array 402 defines a grid that may be identified by X-Y coordinates corresponding to a bit at a particular location in cache array 402.

As known in the art, during a composite repair test, each bit in cache array 402 may be tested for errors. In this regard, it should be appreciated that test results file 120 contains data corresponding to whether each bit in cache array 402 for each processor 112 in lot 202 has passed or failed the composite repair test. As briefly described above, cache yield analysis system 100 may be configured to interface with test results file 120 and provide cache yield analysis that may be useful in assessing the design of processors 112 and/or the corresponding manufacture yield. In general, cache yield analysis system 100 searches test results file 120 and determines the cache array locations for which a bit error occurred during testing (i.e., composite repair failed). Based on the identified cache array location(s) that failed the composite repair test during testing of the processors in lot 204, cache yield analysis system 100 may generate a cache repair signature that defines one or more cache array locations that failed in a statistically relevant percentage of the processors in lot 204.

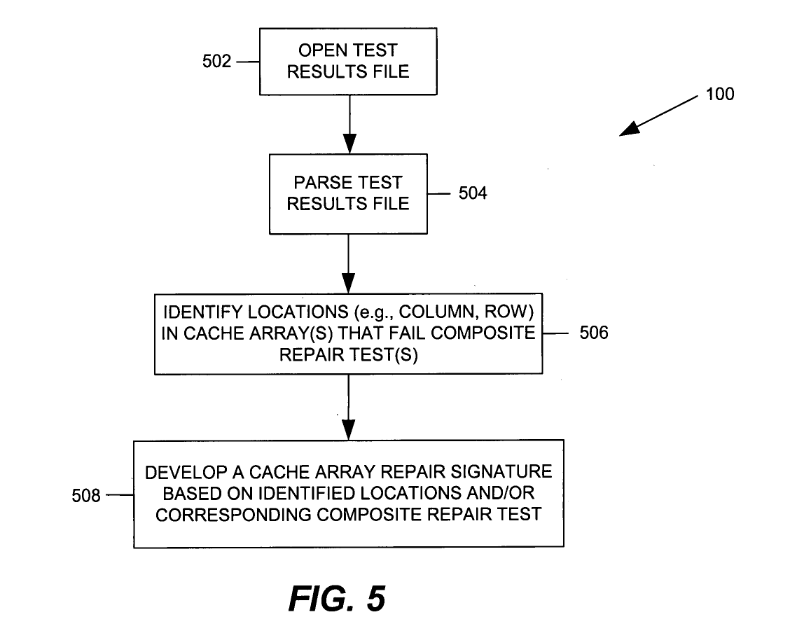

FIG. 5 illustrates the architecture, operation, and/or functionality of an embodiment of cache yield analysis system 100. At block 502, cache yield analysis system 100 opens test results file 120. At block 504, cache yield analysis system 100 parses test results file 120 and, at block 506, identifies the cache array locations that failed the composite repair test. At block 508, cache yield analysis system 100 develops a cache array repair signature based on the cache location(s) identified at block 506. As stated above, the cache array repair signature defines one or more cache array locations associated with the processor design that failed the cache test in a statistically relevant percentage of the processors in lot 204. For example, if cache yield analysis system 100 determines that a particular cache array location fails in a significant number of processors 112, the cache array repair signature will identify this location. One of ordinary skill in the art will appreciate that this type of information may be useful to designers and/or manufacturers to identify problem areas in either the processor design or in the fabrication process.

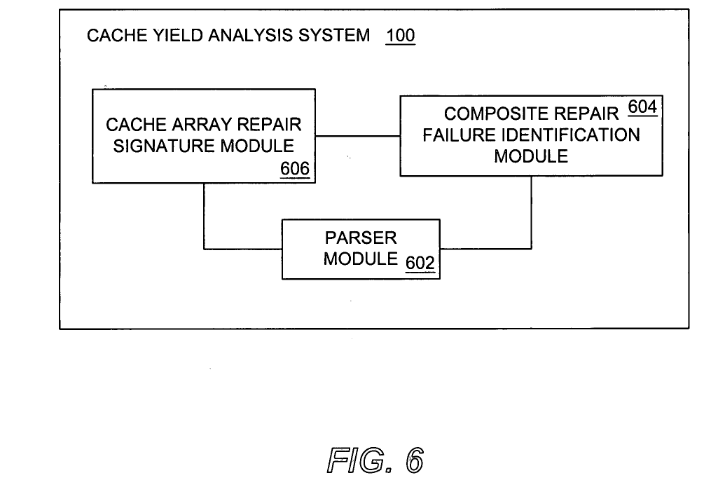

FIG. 6 illustrates another embodiment of cache yield analysis system 100. In the embodiment illustrated in FIG. 6, cache yield analysis system 100 comprises a parser module 602, a composite repair identification module 604, and a cache array repair signature module 606. Parser module 602 may be configured to search test results file 120. Composite repair failure identification module 604 may be configured to determine the cache array locations for which the composite repair test has failed. Depending on the data format of test results file 120, parser module 602 and composite repair identification module 604 may employ a number of types of decoding mechanisms for interpreting the relevant data. Module 606 may be configured to generate the cache array repair signature in the manner described above.

One of ordinary skill in the art will appreciate that cache yield analysis system 100 may be implemented in software, hardware, firmware, or a combination thereof. Accordingly, in one embodiment, cache yield analysis system 100 is implemented in software or firmware that is stored in a memory and that is executed by a suitable instruction execution system. In software embodiments, cache yield analysis system 100 may be written any computer language. In one exemplary embodiment, cache yield analysis system 100 comprises a PERL script.

In hardware embodiments, cache yield analysis system 100 may be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

It should be appreciated that the process descriptions or blocks related to FIGS. 5 and 6 represent modules, segments, or portions of code which include one or more executable instructions for implementing specific logical functions or steps in the process. It should be further appreciated that any logical functions may be executed out of order from that shown or discussed, including substantially concurrently or in reverse order, depending on the functionality involved, as would be understood by those reasonably skilled in the art.

Furthermore, cache yield analysis system 100 may be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

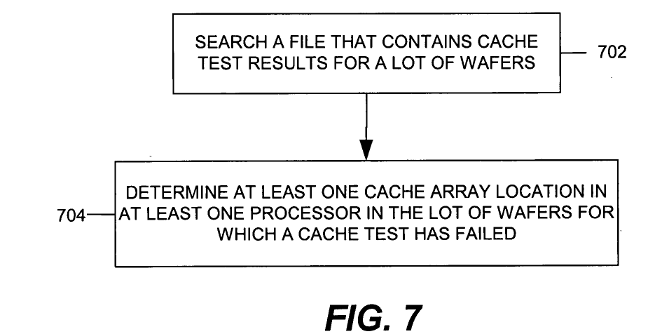

In view of the disclosure above, it will be appreciated that one embodiment of a method for testing cache performance of a processor design is illustrated in FIG. 7. As illustrated in FIG. 7, the method may comprise: searching a file that contains cache test results for a lot of wafers; and determining at least one cache array location in at least one processor in the lot wafers processor for which a cache test has failed.

1. A method for testing cache performance of a processor design, the method comprising:
searching a file that contains cache test results for a lot of wafers; and
determining at least one cache array location in at least one processor in the lot wafers processor for which a cache test has failed.

2. The method of claim 1, wherein the searching the file comprises parsing the file.

3. The method of claim 1, wherein the searching the file comprises opening the file and parsing the file.

4. The method of claim 1, wherein the determining the at least one cache array location comprises determining a column and row location in the corresponding cache array.

5. The method of claim 1, further comprising developing a cache array repair signature based on the at least one cache array location for which a cache test has failed.

6. The method of claim 5, wherein the cache array repair signature defines a cache array location associated with the processor design which has failed the cache test in a statistically relevant percentage of the processors in the lot.

7. A system for testing cache performance of a processor design, the system comprising:
a parser module for searching a file that contains cache test results for a lot of wafers;
a composite repair failure identification module for determining cache array locations for which a cache test has failed; and
a cache array repair signature module for determining at least one cache array location associated with the processor design which has failed the cache test in a statistically relevant percentage of the processors in the lot.

8. The system of claim 7, wherein the parser module is configured to open the file that contains the cache test results.

9. The system of claim 7, wherein the parser module, the composite repair failure identification module, and the cache array repair signature module comprise software that is executed by a processor.

10. The system of claim 7, wherein the cache array repair signature module is configured to determine a column and row location in the corresponding cache array.

11. A cache yield analysis program embodied in a computer-readable medium, the program comprising:
logic configured to search a file that contains test results for a lot of wafers and determine cache array locations for processors in the lot for which a cache test has failed; and
logic configured to determine a cache array repair signature that defines at least one cache array location associated with the processor design which has failed the cache test in a statistically relevant percentage of the processors in the lot.

12. The program of claim 11, wherein the logic configured to determine a cache array repair signature is further configured to determine a column and row location in the corresponding cache array.

13. A system for testing cache performance of a processor design, the system comprising:
means for searching a file that contains test results for a lot of wafers;
means for determining cache array locations for processors in the lot for which a cache test has failed; and
means for generating a cache array repair signature that defines at least one cache array location associated with the processor design which has failed the cache test in a statistically relevant percentage of the processors in the lot.
